(19) United States
(12) Patent Application Publication
(10) Pub. No.: US 2024/0192621 A1
(43) Pub. Date: Jun. 13, 2024

(54) NOVEL TONER EXTERNAL ADDITIVE AND TONER COMPOSITION COMPRISING SAME

(71) Applicant: LOTTE FINE CHEMICAL CO., LTD., Ulsan (KR)

(72) Inventors: Dae Woong Choi, Ulsan (KR); Ji Soo Lee, Ulsan (KR)

(73) Assignee: LOTTE FINE CHEMICAL CO., LTD., Ulsan (KR)

(21) Appl. No.: 18/551,358

(22) PCT Filed: May 18, 2022
(86) PCT No.: PCT/IB2022/054591

§ 371 Date: Sep. 19, 2023

(30) Foreign Application Priority Data
Mar. 19, 2021 (KR) 10-2021-0035988

(51) Int. Cl. G03G 9/093; G03G 9/097

(52) U.S. Cl. CPC G03G 9/09385; G03G 9/09307; G03G 9/09708

(57) ABSTRACT

A toner external additive composition of the present invention comprises, as a core component, tin oxide, to be usable as an alternative material for conventional titanium dioxide (TiO₂), and thus can respond to future regulations on titanium dioxide and environment. In addition, the toner external additive composition and a toner composition comprising same comprise, as a shell component, a silane-based compound and aluminum hydroxide to reduce triboelectric charge so that a ghost phenomenon is alleviated and increase image density so that print quality is improved. Particularly, if aluminum hydroxide is used in a specific amount range, a print quality improvement effect can be further improved.

### TECHNICAL FIELD

The present disclosure relates to an external additive for a toner and a toner composition containing the same, and more particularly relates to an external additive for a toner and a toner composition containing the same, where the external additive for the toner has a core-shell structure in which a core contains tin oxide and a shell contains both aluminum hydroxide and a silane-based compound.

### BACKGROUND ART

Toner, a developing material for a laser printer, typically contains toner base particles and external additives for the toner applied on a part or all of the surface of the toner base particles. The external additive for the toner, applied on the toner base particles, is a key component that affects print quality by controlling triboelectric stability, environmental stability, powder fluidity, and the like.

As the main component of existing external additives for toners, titanium dioxide (TiO₂) was used. However, in October 2019, the EU revised the Commission Delegated Regulation (EU) 2020/217 to specify titanium dioxide having a particle size of 10 microns or less, previously considered a probable carcinogen, as a regulated substance. Specifically, when the toner contains 1 wt % or more of titanium dioxide, a warning about inhalation must be labeled on the surface of the packaging. The revised regulations were to be effective in October 2021 for toner compositions containing titanium dioxide and additives thereof, so the need for alternative materials for titanium dioxide emerged.

Referring to FIG. 1, which shows a diagram of discharge charge amounts according to the metal-ion electronegativity of metal oxides, silica (SiO₂), alumina (Al₂O₃), iron oxide (Fe₃O₄), and the like are known as alternative materials for titanium dioxide (TiO₂) constituting a core and serving as the main component of an external additive for a toner. However, tin dioxide (SnO₂) may be selected in terms of electronegativity similar to that of titanium dioxide.

Regarding toner compositions using tin oxides, including tin dioxide, and additives thereof, U.S. Pat. No. 5,135,832 (registered on Aug. 4, 1992) relates to a colored toner composition. Specifically, disclosed is a toner composition containing a core material encapsulated by a polymer shell containing a metal oxide, a binder resin, a pigment, and the like, where the core material may be subjected to hydrophobic surface treatment with a silane compound.

In addition, U.S. Pat. No. 5,783,345A (registered on Jul. 21, 1998) relates to an image formation method. Specifically, disclosed is that a developing layer formed on a roller-type rotor includes a carrier and a toner, wherein the toner is made up of conductive inorganic microparticles, such as titanium oxide, tin oxide, and the like, and may be subjected to surface treatment with a silane coupling agent.

Furthermore, Korean Patent No. 10-0427201 (published on Apr. 17, 2004) relates to a magnetic toner. Specifically, disclosed is a magnetic toner containing a binder resin, magnetic toner particles containing magnetic powder, and inorganic fine powder, wherein the inorganic fine powder may include zinc oxide, tin oxide, and the like, and may be subjected to hydrophobic surface treatment with a silane-based material.

However, in the technology field of toner compositions to which the documents of the related art belong, in particular, external additives for toners, research and development on alternative materials for titanium dioxide, serving as a core component, is necessary. In addition, research and development on post-treatment technology capable of providing functionality to the alternative material for titanium dioxide and exhibiting the effect of improving physical properties are also in need because the print quality of the toner composition containing the external additive is affected.

### DISCLOSURE

### Technical Problem

To solve the problems described above, an external additive composition for a toner of the present disclosure, composed of a core and a shell, aims to meet environmental regulations by containing tin oxide as an alternative material for titanium dioxide (TiO₂) serving as a core component.

In addition, the external additive composition for the toner and a toner composition containing the same aim to improve ghosting (image defects occurring when a toner fails to be easily transferred from a developing roller to OPC due to an excessively high triboelectric charge amount and is eventually insufficiently transferred to paper) and to increase image density so that the print quality is improved by containing a silane-based compound applied on a part or all of the core as one component of the shell to maintain excellent durability and containing aluminum hydroxide as another component to reduce triboelectric charge amount.

### Technical Solution

To solve the problems described above, the present disclosure provides an external additive for a toner characterized by containing particles composed of: a core containing tin oxide; and a shell in which a part or all of the core is coated with a silane-based compound and aluminum hydroxide.

In one embodiment of the present disclosure, the silane-based compound may be an alkoxysilane, specifically, alkyltrialkoxysilane, and more specifically, isobutyltrialkoxysilane.

In another embodiment of the present disclosure, in the external additive for the toner, the tin oxide is characterized by having a content in a range of 40 to 89.95 wt %, the silane-based compound is characterized by having a content in a range of 10 to 50 wt %, and the aluminum hydroxide is characterized by having a content in a range of 0.05 to 10 wt %.

The present disclosure provides a method of preparing an external additive composition for a toner, the method characterized by including step (A) of obtaining tin oxide particles coated with a silane-based compound by adding tin oxide particles dropwise to a solution containing the silane-based compound and stirring the resulting solution, and step (B) of obtaining external additive particles for a toner by adding the tin oxide particles coated with the silane-based compound obtained in (A) step dropwise to a solution containing aluminum hydroxide and stirring the resulting solution.

Another embodiment of the present disclosure provides a toner composition characterized by containing 0.1 to 1.5 parts by weight of the external additive for the toner according to the present disclosure, with respect to 100 parts by weight of toner base particles.

In addition, the present disclosure provides a method of preparing a toner composition, the method characterized by including step (a) of preparing toner base particles by polymerizing a polymer latex through emulsion polymerization using a resin monomer, mixing the polymer latex with a pigment dispersion, a wax dispersion, and a coagulant, and then subjecting the resulting mixture to coagulation and coalescence processes, step (b) of washing and drying the selected toner base particles, and step (c) of impregnating the toner base particles with the external additive for the toner according to the present disclosure.

### Advantageous Effects

In an external additive for a toner of the present disclosure, tin oxide is contained as a core component and usable as an alternative material for existing titanium dioxide (TiO₂), thus responding to further regulations on the use of titanium dioxide and the environment.

In addition, a toner composition containing the external additive for the toner of the present disclosure has excellent durability, improves ghosting, and increases image density, thereby improving print quality.

### DESCRIPTION OF DRAWINGS

FIG. 1 shows a diagram of discharge charge amounts according to the metal-ion electronegativity of metal oxides; and; and

FIG. 2 shows an image chart printed to determine the occurrence of ghosting according to Experimental Example 3.

### BEST MODE

Unless defined otherwise, all terms including technical and scientific terms used herein have the same meaning as commonly understood by those skilled in the art to which the present disclosure belongs. Typically, the nomenclature used herein is well-known and commonly used in the art.

In addition, in the following description of the present disclosure, when it is determined that the detailed description of the known art related to the present disclosure might obscure the gist of the present disclosure, the detailed description thereof will be omitted.

Features of various embodiments of the present disclosure may be partially or entirely coupled to or combined with each other, and may be variously inter-operated with each other and driven technically as those skilled in the art can sufficiently understand. The embodiments of the present disclosure may be carried out independently from each other, or may be carried out together in co-dependent relationship.

Hereinafter, an external additive for a toner of the present disclosure will be described in detail.

The present disclosure relates to an external additive for a toner, which is characterized by containing external additive particles composed of: a core containing tin oxide; and a shell in which a part or all of the core is coated with a silane-based compound and aluminum hydroxide. In addition, the present disclosure is technically characterized in that when a toner composition contains the external additive for the toner, toner base particles are impregnated with the external additive particles, thereby improving print quality.

The tin oxide, serving as the main component of the core constituting the particles in the external additive composition for the toner, is a metal oxide represented by Formula 1.

SnₓO_{y} (where y/x is in a range of 1 to 2.) (Formula 1)

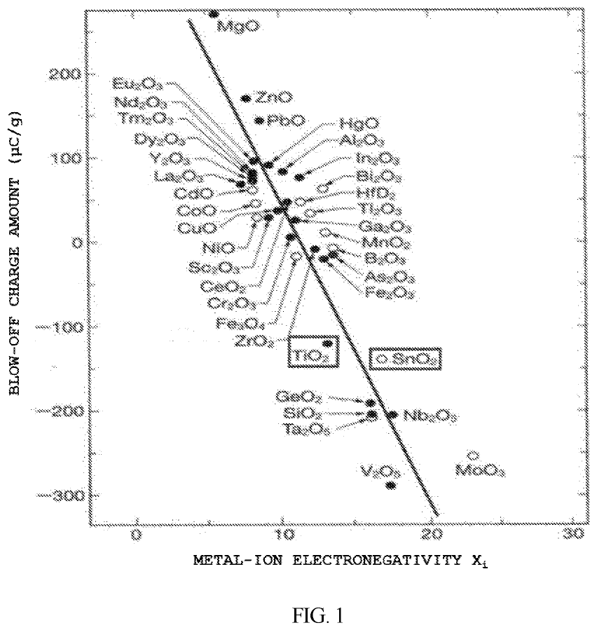

Referring to FIG. 1, which shows a diagram of discharge charge amounts according to the metal-ion electronegativity of metal oxides, silica (SiO₂), alumina (Al₂O₃), iron oxide (Fe₃O₄), and the like are known as alternative materials for titanium dioxide (TiO₂). However, tin dioxide (SnO₂) that has electronegativity similar to that of titanium dioxide is preferably used.

On the other hand, the silane-based compound, serving as one component of the shell, with which a part or all of the core constituting the particles in the external additive composition for the toner is coated contributes to improving environmental stability including durability.

The silane-based compound includes an alkoxysilane, and examples of the alkoxysilane used may include ethyltriethoxysilane, ethyltrimethoxysilane, ethyltri-n-propoxysilane, isobutyltriethoxysilane, isobutyltrimethoxysilane, isobutyltriacetoxysilane, n-hexyltrimethoxysilane, vinyltriethoxysilane, phenyltrimethoxysilane, octylmethyldiisopropoxysilane, lauryltrimethoxysilane, 2-ethylhexyltrimethoxysilane, octyltriethoxysilane, dodecyltribromosilane, tetradecyltrimethoxysilane, hexadecyltriethoxysilane, and octadecyltriethoxysilane. However, a trialkoxysilane is preferably used, and isobutyltriethoxysilane is most preferably used.

When using the alkoxysilane as the silane-based compound, the hydrophobicity degree of the external additive is increased, so the durability and environmental resistance of the toner may be effectively improved.

The aluminum hydroxide (Al(OH)₃), which is a technical feature of the present disclosure, serves as another component of the shell with which a part or all of the core constituting the particles in the external additive composition for the toner is coated, along with the silane-based compound. When impregnating the toner base particles with external additive particles for the toner, containing the aluminum hydroxide, the triboelectric charge amount generated between the particles in the toner composition is reduced, thereby improving ghosting. In addition, the image density is increased, thereby improving print quality.

In the external additive for the toner according to the present disclosure, the tin oxide may have a content in a range of 40 to 89.95 wt %, the silane-based compound may have a content in a range of 10 to 50 wt %, and the aluminum hydroxide may have a content in a range of 0.05 to 10 wt %. More preferably, the tin oxide has a content in a range of 53 to 79.9 wt %, the silane-based compound has a content in a range of 20 to 40 wt %, and the aluminum hydroxide has a content in a range of 0.1 to 7 wt %.

When the silane-based compound has a content of less than 10 wt %, the hydrophobicity degree of the external additive is reduced, thereby deteriorating the environmental resistance of the toner. When the silane-based compound has a content exceeding 50 wt %, the excessive amount added causes a problem of poor economic feasibility.

In addition, when the aluminum hydroxide has a content of less than 0.05 wt %, the LL environmental charge amount of the toner composition containing the aluminum hydroxide is increased due to friction, thereby causing ghosting. In addition, there may be a problem in that the image density is decreased, thereby deteriorating print quality. When the aluminum hydroxide has a content exceeding 10 wt %, the excessive amount of the aluminum hydroxide, with respect to that of the tin oxide contained in the core, results in poor economic feasibility and a decrease in application efficiency on the core. In addition, there may be problems in that excessively reduced triboelectric charge amount results in an excessive increase in image density, and the toner consumption is excessively increased.

Another aspect of the present disclosure provides a method of preparing an external additive composition for a toner. In addition, all of the external additive compositions for the toner described above may be applied to the method of preparing the external additive composition for the toner. However, redundant descriptions will be omitted to prevent the nature of the present disclosure from being obscured.

In addition, the present disclosure may provide the method of preparing the external additive composition for the toner. The method includes step (A) of obtaining tin oxide particles coated with a silane-based compound by adding tin oxide particles dropwise to a solution containing the silane-based compound and stirring the resulting solution, and step (B) of obtaining external additive particles for a toner by adding the tin oxide particles coated with the silane-based compound obtained in (A) step dropwise to a solution containing aluminum hydroxide and stirring the resulting solution.

After coating the tin oxide particles in (A) or (B) step, washing and drying processes may be selectively involved. In addition, the washing and drying processes may be performed by a known method of washing and drying after coating metal oxide.

The method of preparing the external additive composition for the toner of the present disclosure is only described as one embodiment in which the coating is sequentially performed with the silane-based compound, followed by aluminum hydroxide, but is not limited to the sequential coating order described above. In another embodiment of the present disclosure, the sequential coating order may vary, so sequential coating may be performed with the silane-based compound, followed by aluminum hydroxide, or simultaneous coating may be performed with a mixed solution of aluminum hydroxide and the silane-based compound.

In addition, the present disclosure is characterized in that the toner composition contains 0.1 to 1.5 parts by weight of the external additive for the toner according to the present disclosure, with respect to 100 parts by weight of the toner base particles.

When the toner composition contains less than 0.1 wt % of the external additive for the toner according to the present disclosure, there may be a problem in that the effects of maintaining the durability and reducing triboelectric charge amount fail to be exhibited. When the toner composition contains more than 1.5 wt % of the external additive for the toner, there may be a problem in that the effects of maintaining the durability and reducing triboelectric charge amount fail to be further improved, with respect to the added amount, thus being economically infeasible.

The toner base particles determine the shape, diameter, and particle size of toner particles, and include a polymer latex resin, a pigment, and a wax as a substrate impregnated with the external additive for the toner. The toner base particles may have a content in a range of 90 to 98 wt %, with respect to 100 wt % of the entire toner composition.

As for the polymer latex resin, a known latex resin may be used as a matrix resin of the toner base particles. However, polyester resins, polyester resin mixtures, polyester copolymer resins, styrene-acrylate resins, and the like that are widely known as general materials for latex resins may be used.

As for the pigment that is a component used for color development of the toner composition, one or more pigments selected from among black, cyan, magenta, and yellow colors may be used.

As for the wax that is a component used for improving releasability between a photosensitive roller and the toner in a step of transferring and fixing the toner to an image receptor such as a printing paper, one or more types of wax among polyethylene-based wax, polypropylene-based wax, silicone wax, paraffin-based wax, synthetic ester-based wax, carnauba wax, and metallocene wax may be used without limitation.

In addition, other additives may be contained as additional components that provide the functionality required for the toner. Types of other additives may include UV stabilizers, anti-mold agents, bactericides, charge control agents, gloss modifiers, antioxidants, and the like. For example, hydrophobic silica, strontium titanate, polymer beads, and the like may be used. The other additives may have a content in a range of 1 to 9 wt %, with respect to 100 wt % of the entire toner composition.

Another aspect of the present disclosure provides a method of preparing a toner composition. In addition, all of the toner compositions described above may be applied to the method of preparing the toner composition. However, redundant descriptions will be omitted to prevent the nature of the present disclosure from being obscured.

Provided is the method of preparing the toner composition. The method is characterized by including step (a) of preparing toner base particles by polymerizing a polymer latex through emulsion polymerization using a resin monomer, mixing the polymer latex with a pigment dispersion, a wax dispersion, and a coagulant, and then subjecting the resulting mixture to coagulation and coalescence processes, step (b) of washing and drying the selected toner base particles, and step (c) of impregnating the toner base particles with an external additive for a toner according to the present disclosure.

In (a) step, the toner base particles are prepared by mixing the polymer latex prepared through the emulsion polymerization process with a solvent, the pigment dispersion, the wax dispersion, and the coagulant.

The solvent may be water, an aqueous solution, or an organic solvent, and water is preferably used.

The coagulant may be a metal salt containing Si and Fe, and polysilica iron (PSI) is preferably used.

In (b) step of washing and drying the toner base particles, the toner base particles prepared in (a) step are washed with a washing solvent and dried after removing macroparticles.

The macroparticles of the toner base particles may be removed using a known filtration device and method, and the washing and drying steps may also be performed using a known device and method.

In step (c), the toner composition is finally obtained by impregnating the dried toner base particles recovered in step (b) with the external additive for the toner.

The external additive for the toner includes the external additive composition for the toner described above and those derived from the external additive composition for the toner, prepared by the method of preparing the external additive composition for the toner.

Hereinafter, the present disclosure will be described in more detail with reference to preferred embodiments. However, these embodiments are intended to explain the present disclosure in more detail, and it will be apparent to those skilled in the art that the scope of the present disclosure is not limited thereto.

### Preparation Examples 1 to 7 and Comparative Preparation

### Examples 1 to 3: Preparation of External Additive Composition for Toner

Tin dioxide (SnO₂) was added to a solution containing isobutyltriethoxysilane (IBTES) and stirred. Then, the resulting solution was filtered and dried to obtain tin dioxide particles coated with isobutyltriethoxysilane. The obtained tin dioxide particles coated with isobutyltriethoxysilane were added to a solution containing aluminum hydroxide (Al(OH)₃) and stirred to prepare external additive particles for a toner. Each content of the tin dioxide (SnO₂), aluminum hydroxide (Al(OH)₃), and isobutyltriethoxysilane (IBTES) is shown in Table 1.

TABLE 1

| | | | | | | | | Prepa- | Prepa- | Prepa- |
|---|---|---|---|---|---|---|---|---|---|---|
| | | | | | | | | ration | ration | ration |
| External | Prepa- | Prepa- | Prepa- | Prepa- | Prepa- | Prepa- | Prepa- | Compar- | Compar- | Compar- |
| additive | ration | ration | ration | ration | ration | ration | ration | ative | ative | ative |
| composition | Exam- | Exam- | Exam- | Exam- | Exam- | Exam- | Exam- | Exam- | Exam- | Exam- |
| for toner | ple 1 | ple 2 | ple 3 | ple 4 | ple 5 | ple 6 | ple 7 | ple 1 | ple 2 | ple 3 |
| SnO₂ (wt %) | 69.9 | 69.5 | 69.0 | 67.0 | 63.0 | 79.0 | 59.0 | 70.0 | 60.0 | 80.0 |
| IBTES (wt %) | 30.0 | 30.0 | 30.0 | 30.0 | 30.0 | 20.0 | 40.0 | 30.0 | 40.0 | 20.0 |
| Al(OH)₃ | 0.1 | 0.5 | 1.0 | 3.0 | 7.0 | 1.0 | 1.0 | — | — | — |
| (wt %) | | | | | | | | | | |
| Total | 100.0 | 100.0 | 100.0 | 100.0 | 100.0 | 100.0 | 100.0 | 100.0 | 100.0 | 100.0 |
| amount | | | | | | | | | | |
| (wt %) | | | | | | | | | | |

### Examples 1 to 7 and Comparative Examples 1 to 3: Preparation of Toner Composition

A latex resin was polymerized through emulsion polymerization. Then, the latex resin was mixed with a solvent, a pigment dispersion, a wax dispersion, a coagulant, and hydrophobic silica serving as the other additive to prepare toner base particles. Next, the toner base particles were filtered for selection, and the selected toner base particles were washed and dried. The toner base particles were impregnated with an external additive for a toner derived from one of the external additive compositions for the toner, prepared in Preparation Examples 1 to 7 and Comparative Preparation Examples 1 to 3, to prepare a toner composition. Each content of the toner base particles, external additive for the toner, and hydrophobic silica is shown in Table 2 below.

TABLE 2

| | | | | | | | | Compar- | Compar- | Compar- |
|---|---|---|---|---|---|---|---|---|---|---|
| | | | | | | | | ative | ative | ative |
| Toner | Exam- | Exam- | Exam- | Exam- | Exam- | Exam- | Exam- | Exam- | Exam- | Exam- |
| composition | ple 1 | ple 2 | ple 3 | ple 4 | ple 5 | ple 6 | ple 7 | ple 1 | ple 2 | ple 3 |
| Toner | 95.17 | 95.17 | 95.17 | 95.17 | 95.17 | 95.17 | 95.17 | 95.17 | 95.17 | 95.17 |
| particle | | | | | | | | | | |
| Hydrophobic | 4.36 | 4.36 | 4.36 | 4.36 | 4.36 | 4.36 | 4.36 | 4.36 | 4.36 | 4.36 |
| silica | | | | | | | | | | |
| SnO₂ | 0.48 | 0.48 | 0.48 | 0.48 | 0.48 | 0.48 | 0.48 | 0.48 | 0.48 | 0.48 |
| external | | | | | | | | | | |
| additive | | | | | | | | | | |
| Total | 100.0 | 100 | 100 | 100 | 100 | 100 | 100 | 100 | 100 | 100 |
| amount | | | | | | | | | | |

### Experimental Example 1: Powder Fluidity Measurement

3 g of each of the toner compositions of examples and comparative examples were left under the following N/N environmental conditions: a temperature of 23° C. and a relative humidity of 55% for 2 hours. Then, 2 g of each toner composition was loaded onto an upper portion of a sieve made up of the upper portion (53 μm), a middle portion (45 μm), and a lower portion (38 μm). Next, after setting the amplitude on Dial 3, a vibration was applied for 40 seconds. When the vibration stopped, powder fluidity measurement was performed by measuring the weight of the toner composition remaining in the upper, middle, or lower portion of the sieve having the corresponding diameter. The measurement results thereof are shown in Table 3 below. The powder fluidity was calculated by the following equation.

[(m(53 um)×5/5+m(45 um)×3/5+m(38 um)×1/5)÷m(initial)]×100
m (diameter): weight (g) of toner composition remaining in upper, middle, or lower portion of sieve having corresponding diameter
m (initial): weight (g) of toner composition initially loaded onto upper portion of sieve

### Experimental Example 2: LL Environmental Charge Amount Analysis

7 g and 93 g of the each of toner compositions, prepared in examples and comparative examples, and a carrier were added to a 50 ml container, respectively, left under the following LL environmental conditions: a temperature of 10° C. and a relative humidity of 10% for 10 hours, and then mixed for 10 minutes using a tumbler mixer. Next, 1 g of a mixture of the toner composition and the carrier was left in an LL environmental chamber for 5 minutes and put into a cell of Epping Q/M meter, a charge amount analyzer. Then, charge amount analysis was performed for 90 seconds. When measuring the weight of the cell after completion of the charge amount analysis and inputting the initial weight, the charge amount value was derived. The charge amount values are shown in Table 3 below.

### Experimental Example 3: Image Chart Analysis to Determine Occurrence of Ghosting

An image chart for confirming ghosting was printed using the toner compositions of examples and comparative examples. Then, the occurrence of ghosting was confirmed.

When visually observing the image chart at a distance of 30 cm apart therefrom, the determination criteria for the occurrence of ghosting were determined as follows: “excellent” when ghosting was not observed by all observers, “good” when ghosting was slightly visible to some observers, and “poor” when ghosting was clearly observed by all observers.

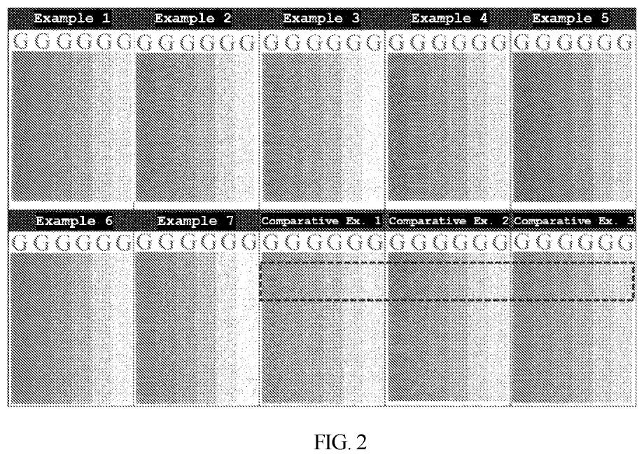

The printed image chart is shown in FIG. 2. In this case, a part where ghosting occurs is indicated by a dotted line box. In addition, the image chart analysis results to determine the occurrence of ghosting are shown in Table 3 below.

### Experimental Example 4: Image Density Measurement

A toner cartridge of a laser printer (model name: C-3010) was filled with 100 g of each of the toner compositions of examples and comparative examples. Then, the image density was measured using a SpectroEye colorimetric analyzer for pattern charts printed at uniform intervals. The results thereof are shown in Table 3 below.

### Experimental Example 5: Durability Evaluation

A toner cartridge of a laser printer (model name: C-3010) was filled with 100 g of each of the toner compositions of examples and comparative examples. Then, the entire quantity of guaranteed copies of the laser printer was printed to check the occurrence of streaking in the printing direction. The streaking is a phenomenon in which the toner composition fails to withstand the stress inside the cartridge due to poor durability and becomes fused or fixed, causing streak-shaped defects in the printing direction.

The determination criteria for durability evaluation were determined as follows: “excellent” when there were no streaks found in the printing direction in the entire number of copies of the guaranteed copies, “normal” when there were 5 or fewer streaks per page, and “defective” when there were 10 or more streaks per page.

The durability evaluation results are shown in Table 3 below.

TABLE 3

| | | | | | | | | Compar- | Compar- | Compar- |
|---|---|---|---|---|---|---|---|---|---|---|
| | | | | | | | | ative | ative | ative |
| | Exam- | Exam- | Exam- | Exam- | Exam- | Exam- | Exam- | Exam- | Exam- | Exam- |
| Criteria | ple 1 | ple 2 | ple 3 | ple 4 | ple 5 | ple 6 | ple 7 | ple 1 | ple 2 | ple 3 |
| Powder | 11 | 13 | 12 | 12 | 13 | 11 | 12 | 12 | 13 | 13 |
| fluidity (%) | | | | | | | | | | |
| LL | 46.8 | 45.7 | 43.7 | 41.5 | 40.5 | 44.1 | 43.2 | 57.2 | 59.1 | 57.9 |
| environmental | | | | | | | | | | |
| charge amount | | | | | | | | | | |
| (−μ/g) | | | | | | | | | | |
| Ghosting | Good | Good | Excellent | Excellent | Excellent | Excellent | Excellent | Poor | Poor | Poor |
| Image density | 1.18 | 1.19 | 1.21 | 1.24 | 1.26 | 1.22 | 1.23 | 1.05 | 1.03 | 1.07 |
| Durability | Excellent | Excellent | Excellent | Excellent | Excellent | Excellent | Excellent | Excellent | Excellent | Excellent |

Referring to Table 3, compared to the toner compositions of Comparative Examples 1 to 3, it was confirmed that each of the toner compositions of Examples 1 to/had a lower LL environmental charge amount, an indicator of triboelectric charge amount, thereby improving ghosting, and had increased image density, thereby improving print quality.

In particular, in the toner compositions of Examples 1 to 5, the higher the amount of aluminum hydroxide, the smaller the LL environmental charge amount. In addition, ghosting was improved, and the image density was increased.

Referring to the durability evaluation results shown in Table 3, compared to the case of Comparative Examples 1 to 3, the toner compositions in the case of Examples 1 to 7 appeared to maintain excellent durability even though a part of the silane-based compound applied on the external additive particles in the composition was replaced with aluminum hydroxide.

The Examples of the present disclosure previously described should not be interpreted to limit the technical spirit of the present disclosure. The scope of the present disclosure to be protected is limited only by the matters described in the claims, and those skilled in the art of the present disclosure can improve and change the technical spirit of the present disclosure in various forms. Therefore, such improvements and changes would fall within the scope of the present disclosure to be protected as long as they are obvious to those skilled in the art.

1. An external additive for a toner, the external additive comprising particles composed of:
a core containing tin oxide; and
a shell in which a part or all of the core is coated with a silane-based compound and aluminum hydroxide.

2. The external additive of claim 1, wherein the silane-based compound is an alkoxysilane.

3. The external additive of claim 1, wherein the silane-based compound is an alkyltrialkoxysilane.

4. The external additive of claim 1, wherein the silane-based compound is isobutyltrialkoxysilane.

5. The external additive of claim 1, wherein the tin oxide has a content in a range of 40 to 89.95 wt %, the silane-based compound has a content in a range of 10 to 50 wt %, and the aluminum hydroxide has a content in a range of 0.05 to 10 wt %.

6. A method of preparing an external additive for a toner, the method comprising:
(A) obtaining tin oxide particles coated with a silane-based compound by adding tin oxide particles dropwise to a solution containing the silane-based compound and stirring a resulting solution; and
(B) obtaining external additive particles for a toner by adding the tin oxide particles coated with the silane-based compound obtained in the (A) obtaining dropwise to a solution containing aluminum hydroxide and stirring the resulting solution.

7. A toner composition comprising 0.1% to 1.5% by weight of the external additive of claim 1, with respect to 100% by weight of an entire toner composition.

8. A method of preparing a toner composition, the method comprising:
(a) preparing toner base particles by polymerizing a polymer latex through emulsion polymerization using a resin monomer, mixing the polymer latex with a pigment dispersion, a wax dispersion, and a coagulant, and then subjecting a resulting mixture to coagulation and coalescence processes;
(b) washing and drying selected toner base particles; and
(c) impregnating the toner base particles with the external additive of claim 1.
